(19) United States
(12) Patent Application Publication
(10) Pub. No.: US 2026/0368988 A1
(43) Pub. Date: Nov. 19, 2026

(54) SEAMLESS AI AVATAR SCENE TRANSITION SYSTEM

(71) Applicant: 2wai Inc., Bal Harbour, FL (US)

(72) Inventors: James Robert Pyers, New River, AZ (US); Jonathan Knapper, Aberdeen (GB); Mason Geyser, West Hills, CA (US); Alex Finden, Encinitas, CA (US)

(73) Assignee: 2wai Inc., Bal Harbour, FL (US)

(21) Appl. No.: 19/675,999

(22) Filed: May 13, 2026

Related U.S. Application Data
(60) Provisional application No. 63/804,954, filed on May 13, 2025.

(51) Int. Cl. G06T 13/40; G06T 13/20; G10L 13/047

(52) U.S. Cl. CPC G06T 13/40; G06T 13/205; G10L 13/047

(57) ABSTRACT

A method includes selecting an anchor frame representing a neutral pose for a given identity and wardrobe combination, for each video clip, generating a head transition segment and a tail transition segment, and assembling the head transition segment, the video clip, and the tail transition segment into a loopable asset whose first and last frames are the anchor frame, for each video clip, generating exit morph segments at regular interior timestamps, each exit morph segment beginning on a frame at a corresponding interior timestamp and ending on the anchor frame, at runtime, sequencing loopable assets by concatenating them through a shared anchor frame, and in response to a determination that a currently playing clip must be exited prior to its natural end, selecting an exit morph segment and playing the exit morph segment to arrive on the anchor frame.

### CROSS-REFERENCE TO RELATED APPLICATIONS

The application claims priority to U.S. Provisional Application Serial No. 63/804,954, filed May 13, 2025, which is hereby incorporated by reference in its entirety.

### FIELD

The present disclosure relates generally to systems and methods for enabling seamless transitions of AI avatars within a scene and between multiple scenes.

### BACKGROUND

Artificial intelligence (AI) avatars have become increasingly prevalent in digital environments, offering users interactive and personalized experiences. These avatars typically operate within static or single-scene environments, limiting their ability to provide dynamic and immersive interactions. The computational demands of rendering high-fidelity 3D environments in real-time have posed challenges for widespread deployment of AI avatars across various platforms and devices. Video-based AI avatars built from a finite library of pre-existing video clips—whether physically captured of real human subjects or generated by AI video models—face an additional tension: the library is finite while conversation is infinite and open-ended, requiring the avatar to respond fluidly in any direction at any moment with arbitrary timing and arbitrary state transitions.

Existing systems often struggle to maintain visual continuity and avatar state preservation when transitioning between different scenes or environments. This can lead to jarring experiences for users, breaking immersion and reducing the effectiveness of avatar-based interactions. Additionally, the lack of seamless navigation between multiple pre-rendered scenes has restricted the potential applications of AI avatars in fields such as interactive storytelling, virtual training, and immersive customer support. Existing approaches to managing avatar motion across clips attempt to bridge this tension by either: (A) generating motion in real time, which incurs high compute cost and uncanny-valley artifacts; (B) hard-cutting between captured or generated clips, which is computationally cheap but produces visible cuts that destroy the illusion of a continuous person; or (C) real-time motion blending, which works for game characters with skeletal rigs but not for high-fidelity photographic video where any blending artifact is immediately perceptible.

Current avatar systems frequently rely on real-time 3D rendering engines, which can be resource-intensive and may not be suitable for deployment on low-power devices or in web-based applications. This limitation has hindered the accessibility and scalability of advanced avatar experiences across diverse platforms and user devices. Furthermore, existing talking-head avatar systems do not address mid-clip exits, multi-state motion encompassing idle, talking, emote, and frame states, or seamless asset-to-asset composition within a library. Most such systems operate in a single-shot mode: a single source clip combined with audio to produce a single talking clip, without supporting interactive avatars composed from a finite library of recombinable assets.

Furthermore, the integration of conversational AI capabilities with visually dynamic avatar systems has presented technical challenges. Maintaining coherent dialogue while simultaneously managing scene transitions and preserving avatar continuity requires sophisticated coordination between multiple system components.

As digital experiences continue to evolve, there is a growing demand for more flexible and efficient methods of creating immersive avatar-based interactions. Users increasingly expect cohesive experiences, coupled with responsive and context-aware avatar behaviors. Meeting these expectations while optimizing computational resources and ensuring broad compatibility across various devices and platforms remains an ongoing challenge in the field of AI avatar systems. There is a particular need for methods that shift the compute cost of transition generation from runtime to ingest, exploit the finite-library structure of source content regardless of how it was originally produced, and avoid real-time motion synthesis entirely while still producing seamlessly interruptible, conversational avatar experiences.

### SUMMARY

In some embodiments, a computer-implemented method for rendering a real-time video avatar from a library of pre-existing video clips is disclosed herein. The method includes selecting or generating an anchor frame representing a neutral pose of a visual identity for a given identity and wardrobe combination, for each pre-existing video clip in the library, generating a head transition segment from the anchor frame to a first frame of the pre-existing video clip and a tail transition segment from a last frame of the pre-existing video clip to the anchor frame, and assembling the head transition segment, the pre-existing video clip, and the tail transition segment into a loopable asset whose first and last frames are the anchor frame, for each pre-existing video clip in the library, generating a plurality of exit morph segments at regular interior timestamps, each exit morph segment beginning on a frame of the pre-existing video clip at a corresponding interior timestamp and ending on the anchor frame, at runtime, sequencing loopable assets into a playback timeline by concatenating them through a shared anchor frame, and in response to a determination that a currently playing clip must be exited prior to its natural end, selecting an exit morph segment from the plurality of exit morph segments and playing the selected exit morph segment to arrive on the anchor frame, from which a next loopable asset is played, wherein runtime transitions between any two clips in the library route through the anchor frame without requiring a direct source-to-destination transition for each clip pair.

In some embodiments, a computer-implemented method for producing a library of seamlessly composable video assets representing a visual identity is disclosed herein. The method includes obtaining a plurality of pre-existing video clips depicting a visual identity, selecting or generating an anchor frame representing a neutral pose of the visual identity for a given identity and wardrobe combination, for each pre-existing video clip, generating a head transition segment beginning on the anchor frame and ending on a first frame of the pre-existing video clip, and a tail transition segment beginning on a last frame of the pre-existing video clip and ending on the anchor frame, assembling, for each pre-existing video clip, the head transition segment, the pre-existing video clip, and the tail transition segment to produce a loopable asset whose first and last frames are the anchor frame, and storing the loopable assets in an asset library, wherein any two loopable assets from the asset library are concatenable with a seamless visual transition by virtue of sharing the anchor frame as a common first and last frame.

In some embodiments, a computer-implemented method for rendering an interruptible video avatar from a clip library is disclosed herein. The method includes maintaining a library of pre-existing video clips depicting a visual identity, each clip having been processed to begin and end on a per-identity-per-wardrobe anchor frame via generated head and tail transition segments, maintaining a morph library comprising, for each pre-existing video clip, a plurality of exit morph segments at interior timestamps within the pre-existing video clip, each exit morph segment beginning on a frame of the pre-existing video clip at a corresponding interior timestamp and ending on the anchor frame, during playback of a current clip, determining that the current clip must be exited prior to its natural end, selecting an exit morph segment from the morph library corresponding to an exit timestamp that is greater than or equal to a current playback position within the current clip; playing the current clip up to the selected exit timestamp, followed by the selected exit morph segment, whereupon the avatar arrives on the anchor frame, and playing a head transition segment of a destination clip from the anchor frame to a first frame of the destination clip, followed by the destination clip.

### BRIEF DESCRIPTION OF THE FIGURES

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1A depicts an exemplary block diagram of a scene transition system in accordance with example embodiments.

FIG. 1B depicts a system diagram for a scene transition system in accordance with example embodiments.

FIG. 2 depicts an illustrative flowchart of a method for managing scene transitions in an avatar system in accordance with example embodiments.

FIG. 3 depicts an exemplary scene navigation map showing relationships and transitions between multiple pre-rendered scenes in accordance with example embodiments.

FIG. 4 depicts a block diagram of an example computing device, in accordance with example embodiments.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

The present disclosure is generally directed to systems and methods for user-generated holographic avatars. In particular, the present disclosure is directed to generating holographic avatars and deploying the holographic avatars in various scenes.

The present disclosure provides systems and methods for enabling seamless transitions of AI-powered avatars between pre-rendered scenes in a virtual environment. The system may integrate a large language model (LLM) with a scene transition framework to support interactive, context-aware dialogue and visually continuous avatar behavior across multiple environments.

The system may include a pre-rendering module for generating photorealistic or stylized scenes, a scene repository storing scenes and metadata, a mapping framework defining spatial and logical relationships between scenes, a transition module for generating smooth visual transitions, and a continuity engine that maintains consistent avatar state, animation, and expression during and after transitions. A frontend interface may capture user input, which may include voice, gestures, or object interaction, and coordinates avatar behavior and scene changes via the integrated LLM.

Upon receiving a transition trigger, the system may identify an appropriate target scene and, optionally, an intermediate transition scene. The avatar may be placed into a transition-ready pose. Coordinate mapping may ensure logical spatial continuity. A transition animation may be generated to preserve visual fidelity. The avatar may be deployed in the target environment with idle or interactive behavior.

The architecture may support a variety of use cases such as interactive storytelling, virtual training, companionship, entertainment, education, healthcare and wellness. The integration of memory mechanisms within the LLM may further enable long-term personalization and context retention across sessions and environments, enhancing realism and user engagement.

The system may be configured to operate across a range of client platforms including, but not limited to, mobile, desktop, browser-based, and XR environments. The system may accommodate cloud or edge-based deployments to optimize performance and scalability.

The avatars, as described herein, may be integrated with a large language model (LLM) to enable sophisticated interactions across various domains. The integration may allow the AI avatar to portray known individuals (e.g., a celebrity), provide companionship, offer wellness and coaching services, facilitate education, participate in roleplay and imaginative scenarios, and/or enhance gaming and collecting experiences.

In some implementations, the LLM may process natural language inputs from users and generate contextually appropriate responses. The model may be trained on vast amounts of text data, allowing it to understand and generate human-like text across a wide range of topics and styles. This capability enables the AI avatar to adapt its personality, knowledge base, and communication style to suit different roles and scenarios.

For celebrity engagement, the system may allow users to interact with AI avatars modeled after famous personalities. The LLM may be fine-tuned on specific celebrity data, including interviews, social media posts, and public statements, to mimic their speech patterns and knowledge base. As users transition between different scenes, the celebrity avatar may seamlessly adapt its conversation to the new environment, maintaining continuity in personality and context.

In companionship applications, the AI avatar may provide emotional support and engage in meaningful conversations across various virtual environments. The LLM may be designed to recognize emotional cues in user input and generate empathetic responses.

For wellness and coaching, the system may incorporate specialized knowledge into the LLM, allowing the AI avatar to offer personalized advice on fitness, nutrition, and mental health. The avatar may guide users through virtual workout spaces, meditation gardens, or cooking scenarios, with the LLM providing relevant information and encouragement tailored to each environment.

In educational contexts, the AI avatar may act as a tutor or guide, leveraging the LLM's broad knowledge base to explain complex concepts across various subjects. The guide may appear as a historical figure. The LLM may be specifically trained on a specific discipline or the knowledge of a particular individual. The scene transition system may allow seamless movement between different learning environments, such as historical recreations, scientific simulations, or virtual classrooms, with the avatar's explanations adapting to each setting.

Roleplay and imagination scenarios may benefit from the LLM's ability to generate creative and contextually appropriate content. Users may engage with AI avatars in fantasy worlds, historical reenactments, or improvised storytelling sessions. The scene transition system may allow fluid movement between imaginary locations, with the LLM maintaining narrative consistency and character roles throughout the transitions.

In gaming and collecting applications, the AI avatar may serve as a game master, opponent, or guide. The LLM may generate dynamic narratives, puzzle clues, or strategic advice based on the game's context. The avatar may be configured to move between different game environments or collecting scenarios, the avatar may provide seamless commentary and interaction, enhancing the immersive experience.

The LLM's functionality may be based on a neural network architecture, such as a transformer model, which processes input text and generates output based on learned patterns and relationships in the training data. The model may use attention mechanisms to focus on relevant parts of the input when generating responses. In some implementations, the LLM may employ few-shot or zero-shot learning capabilities, allowing it to adapt to new tasks or domains with minimal additional training.

The seamless AI avatar scene transition system enables artificial intelligence (AI) avatars to move fluidly within a pre-generated scene and between multiple pre-generated scenes in response to user input. The pre-generated scenes may be photorealistic. The system preserves the avatar's continuity in terms of pose, expression, and animation across scene transitions, allowing for a dynamic and believable virtual experience. In some implementations, the system operates not only at the level of scene-to-scene transitions but also at the level of clip-to-clip transitions within a single scene, where a library of pre-existing video clips depicting a visual identity performing various motion sequences must be composed at runtime into a seamlessly continuous stream. The pre-existing video clips may be obtained by one or more of physical video capture of a real human subject, generation by an artificial-intelligence video generation model from an identity specification, or artificial-intelligence augmentation, restyling, or editing of physically captured video.

In some implementations, scene transitions may occur between distinct environments or separate portions of the same environment. The system may allow for seamless movement of the avatar within a single room or across multiple spaces, providing a more dynamic and interactive experience for the user. The multiple spaces may appear interconnected due to transitions.

For example, an avatar may move from one part of a room to another, such as transitioning from a sitting area to a workspace within the same virtual living room. As the avatar moves, the system may adjust the camera angle, lighting, and background elements to reflect the new position while maintaining continuity of the avatar's state and animations. The avatar may interact with different objects in the room, such as picking up a book from a shelf or sitting down at a desk, with each interaction potentially triggering a micro-transition that updates the avatar's pose and the immediate surroundings.

In some cases, scene transitions may involve changing the avatar's state without necessarily altering the environment. For instance, the system may transition the avatar from a standing idle animation to a seated pose when the user indicates a desire for the avatar to sit down. This type of transition may involve interpolating between different pre-rendered animations or poses to create a smooth and natural-looking movement.

The system may also support more subtle transitions within the same environment. For example, as the avatar moves closer to a window, the lighting on the avatar may gradually change to reflect the natural light coming from outside. Similarly, if the avatar approaches an object of interest, such as a painting on the wall, the system may trigger a transition that slightly adjusts the camera focus and depth of field to draw attention to the artwork.

In some implementations, the system may allow for dynamic scene composition, where elements of the environment can be interactively altered or rearranged. For instance, the avatar may open curtains to reveal a different view outside the window, effectively changing a portion of the scene without requiring a full environment transition. This approach may provide a sense of agency and interactivity within a single pre-rendered environment. In this example, multiple views from the window may be pre-rendered.

The scene transition system may also support transitions between different times of day or weather conditions within the same environment. For example, the avatar may remain in the same room, but the lighting and atmosphere may shift from daytime to evening, with corresponding changes in shadows, color temperature, and ambient sounds. These transitions may occur gradually or more rapidly, depending on the desired effect and narrative context.

The scene transition system may be compatible with various platforms, including browser environments, virtual reality headsets (e.g., in virtual reality, augmented reality, or mixed reality environments), and mobile devices. This versatility enables widespread accessibility and usage across different hardware configurations.

In some implementations, the system may operate on cloud servers or local clients with limited graphics processing unit (GPU) power. This flexibility in deployment allows for scalability and adaptability to different computational resources, reducing the hardware requirements for end-users.

The AI avatar may interact with a user through a large language model. The LLM may process user inputs, generate appropriate responses, and guide the avatar's behavior within the pre-rendered scenes. In certain aspects, the user may control scene transitions directly through a user interface. Alternatively, the user may prompt scene transitions via interaction with the LLM.

The integration of the LLM with the scene transition system may involve coordinating the language generation with the visual transitions. For example, the system may use context tokens or embeddings that represent the current and target scenes, allowing the LLM to generate appropriate transitional dialogue or narration that bridges the gap between environments.

The systems herein may interface with the LLM by sending user inputs (e.g., text, voice, gestures) from the frontend interface to the LLM for natural language processing. The LLM may generate contextually appropriate responses that drive the avatar’s behavior and dialogue. This interaction can be managed via API calls or embedded language models, enabling seamless dialogue generation that integrates with avatar animations, emotional tone, and scene transitions. The system may also employ context tokens or embeddings representing the current and target scenes to guide the LLM's output.

The AI avatar system may also incorporate memory mechanisms that allow the LLM to maintain long-term context across multiple interactions and scene transitions. This may enable more personalized and coherent experiences over extended periods of use, with the avatar recalling previous conversations and user preferences even as the virtual environment changes.

By combining these elements, the seamless AI avatar scene transition system creates a cohesive and interactive experience that simulates fluid movement through complex environments while maintaining the illusion of continuous, intelligent interaction.

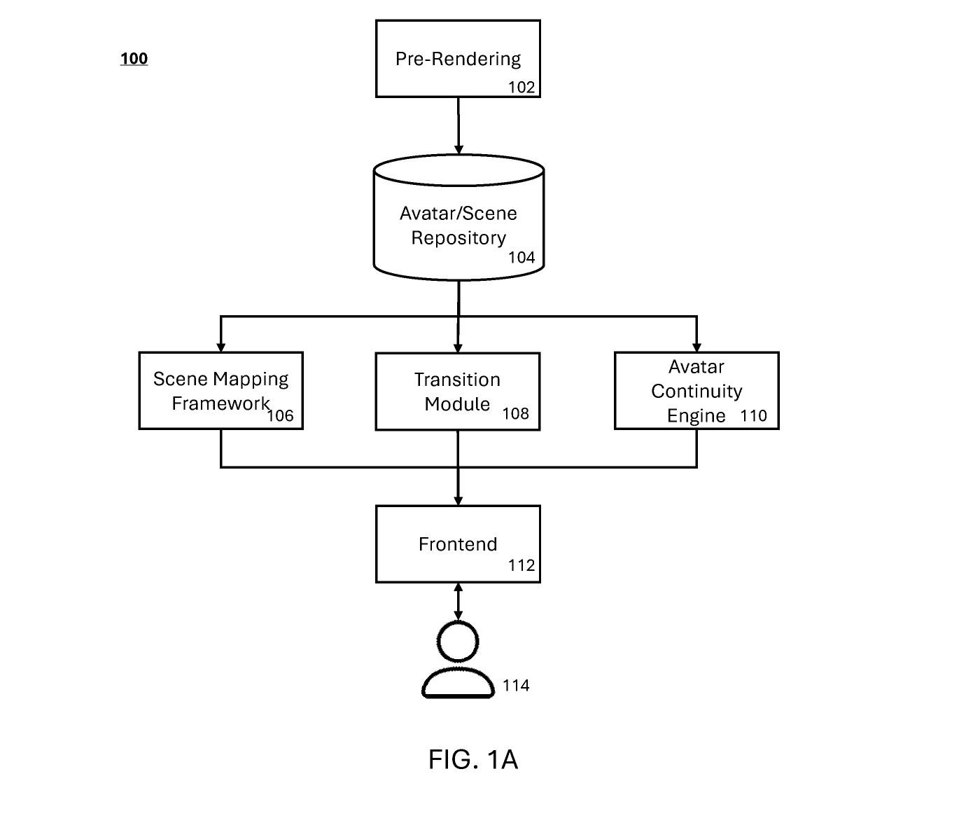

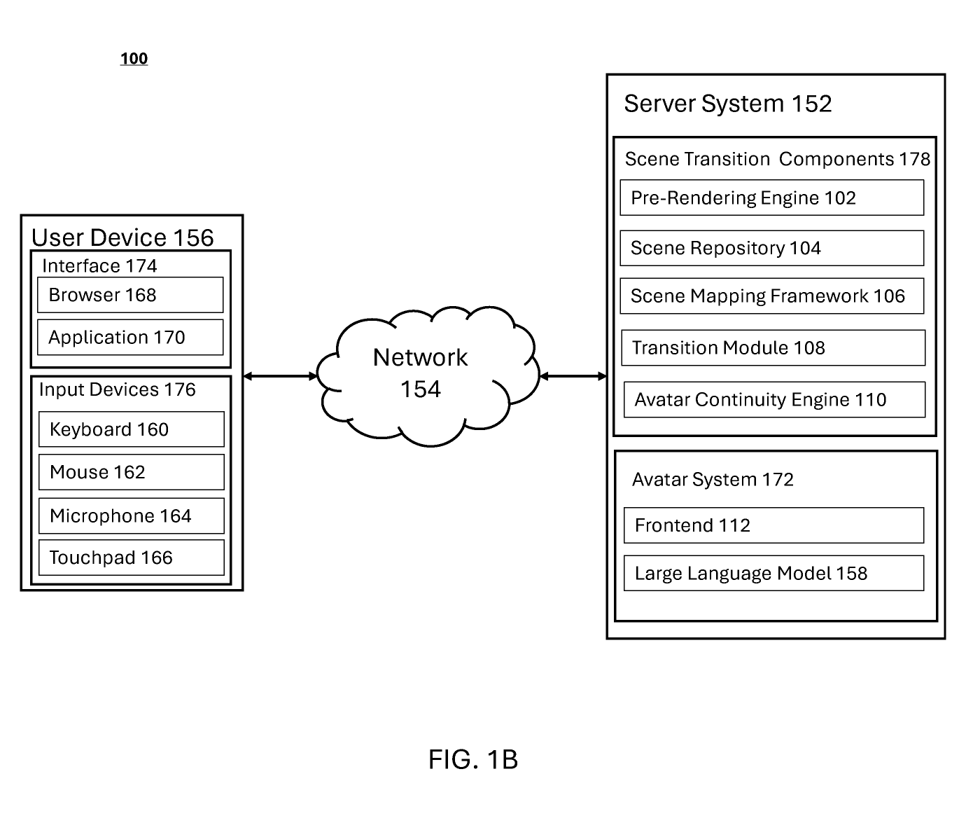

The scene transition system 100 may include several interconnected components that work together to create a seamless avatar experience across multiple pre-rendered environments. FIG. 1A illustrates a block diagram of the scene transition system 100, which may include a pre-rendering module 102, a scene repository 104, a mapping framework 106, a transition module 108, a continuity engine 110, and a frontend interface 112.

These components may communicate via protocols such as HTTP/HTTPS or WebSocket and may use message queues or pub-sub systems for asynchronous processing in distributed environments.

A pre-rendering module 102 may be responsible for generating high-quality scenes that serve as the foundation for the avatar's environment. The scenes may be photorealistic. Alternatively, the scenes may utilize any art style. In some cases, the pre-rendering module 102 may utilize graphical/gaming engines such as Unity or Unreal for scene production. In further aspects, cinematic rendering engines may be used. These engines may allow for the creation of detailed, visually rich environments that can be pre-computed and stored for later use. The pre-rendering module 102 may also support procedurally generated scenes, neural-rendered scenes employing neural radiance fields or similar volumetric techniques, live-captured video backgrounds, and hybrid scenes combining real-time and pre-computed elements.

In some implementations, the pre-rendered scenes may incorporate both 3D and 2D elements to create rich, visually compelling environments. The system may utilize a combination of fully rendered 3D portions for key interactive areas and high-quality 2D backdrops or panoramas for distant or less-frequently accessed parts of the scene. This hybrid approach may allow for optimized performance while maintaining visual fidelity. For instance, the immediate surroundings of the avatar may be rendered in 3D to enable detailed interactions, while distant landscapes or skylines may be represented by 2D images. The transition algorithm may seamlessly blend these 3D and 2D elements during scene changes, employing techniques such as parallax scrolling or depth mapping to enhance the illusion of depth and movement. This flexible composition of scenes may enable the creation of diverse environments while balancing computational requirements and visual quality.

The scene repository 104 may store the pre-rendered scenes along with associated metadata. This metadata may include information about object positions, lighting conditions, and environmental features within each pre-rendered scene. In some implementations, the scene repository 104 may also contain metadata about camera positioning, lighting, and landmark tagging for each scene. The scene repository 104 may further store, for each avatar identity and wardrobe combination, a designated anchor frame referred to herein as a master frame. The master frame may represent a neutral pose of the visual identity and may serve as a per-identity, per-wardrobe canonical frame used as the universal start and end point for every motion asset in the avatar’s library. Selection criteria for the master frame may include eyes open, neutral expression, hands and feet at a documented mark, facing camera, no motion blur, and lighting consistent with the rest of the wardrobe’s footage. In some variants, the master frame may be AI-synthesized by an image generation model conditioned on captured reference imagery rather than extracted from captured footage. This detailed information may be used for maintaining visual consistency during transitions and enabling accurate avatar placement within each environment.

The scene repository 104 may also store transition scenes and avatars along with their associated animations. These transition scenes may serve as intermediate environments that bridge the gap between distinct locations, allowing for smoother visual transitions. The repository may contain a variety of avatar models with different appearances, expressions, and poses, each accompanied by a set of pre-rendered animations. In some implementations, the repository stores, for each pre-existing video clip in an avatar’s library, a loopable asset comprising a head transition segment from the master frame to a first frame of the clip, the original clip, and a tail transition segment from a last frame of the clip back to the master frame. After processing, every asset in a given identity-wardrobe tuple has the property that its first frame and last frame are the master frame, such that any pair of assets from the same identity-wardrobe tuple can be concatenated with an invisible seam. The repository may further store a set of exit morph segments for each clip, each exit morph segment beginning at a designated interior timestamp of the source clip and ending on the master frame, enabling mid-clip interruption without requiring direct source-to-destination transitions for all clip pairs. By storing these elements alongside the main scenes, the system may enable rapid retrieval and composition of complex transitions, reducing load times and enhancing the fluidity of the user experience.

In some implementations, the scene repository 104 includes an AI glue generation pipeline that processes each pre-existing video clip into a loopable asset. The pipeline extracts the first frame and last frame of a source clip, submits a frame pair comprising the master frame and the first frame to a frame-to-frame video generation model to produce a head glue segment, and submits a frame pair comprising the last frame and the master frame to the same or a similar model to produce a tail glue segment. The head and tail glue segments may be short AI-synthesized transition clips of bounded duration. The pipeline concatenates the head glue segment, the original source clip, and the tail glue segment into a loopable asset and stores the loopable asset in the scene repository 104. Original source clips may be preserved in an archival library while the loopable versions replace them in the production library.

In some implementations, the glue segments are generated at a master video specification, such that concatenation with the captured or generated source clip is transparent and downstream pipelines including rendition generation, streaming, and lip synchronization operate uniformly across captured and AI-synthesized frames. Rendition tiers for different streaming bandwidths may be derived from each loopable master, with glue generated once at master quality and rendered across multiple tiers.

In some implementations, the master frame, glue segments, exit morphs, and all transition mechanisms operate identically regardless of whether the pre-existing video clips were physically captured of a real human subject, generated entirely by an AI video generation model from a digital character specification, produced by AI-augmenting or restyling physically captured video, or a hybrid combination thereof. The transition architecture depends on the source content being a finite library of fixed-length video clips that share a coherent visual identity and need to be composed at runtime, and does not depend on the source content being photographic capture of a real human.

In some implementations, the system supports multiple master frame variants. In a first variant, the master frame is selected from physical video capture under neutral-pose discipline and is paired with captured source clips. In a second variant, the master frame is selected from physical capture but source clips have been AI-augmented for style transfer, background replacement, wardrobe substitution, or lighting changes. In a third variant, an AI-synthesized master frame is paired with captured source clips, which may be useful when capture variance prevents clean selection of a neutral pose or when the talent is unavailable. In a fourth variant, both the master frame and all source clips are AI-synthesized, such that the entire pipeline operates on a digital character with no real-world physical referent. In some implementations, a given identity-wardrobe tuple may have a small set of master frames, such as a facing-left master frame and a facing-right master frame, for richer composition.

In some implementations, transitions between different wardrobe configurations are handled by dedicated transition assets that bridge a first master frame for a first wardrobe to a second master frame for a second wardrobe. Within each identity-wardrobe tuple, concatenation seamlessness is guaranteed by the shared master frame, while inter-wardrobe transitions are bridged by these dedicated wardrobe bridge assets.

The scene repository 104 may utilize various database technologies to efficiently store and retrieve pre-rendered scenes and associated metadata. In some implementations, a relational database management system (RDBMS) such as PostgreSQL or MySQL may be employed to organize scene data in structured tables, allowing for complex queries and relationships between different scene elements. Alternatively, a document-oriented NoSQL database like MongoDB or Couchbase may be used to store scene information as flexible, JSON-like documents, which may be particularly useful for handling diverse and evolving metadata schemas.

In some cases, the scene repository 104 may leverage specialized database features to enhance performance and functionality. For instance, a graph database such as Neo4j may be utilized to represent and query complex spatial relationships between scenes, facilitating efficient pathfinding for transitions. Additionally, the repository may incorporate a distributed cache system like Redis to store frequently accessed scene data in memory, potentially reducing latency during scene transitions. Some implementations may also employ a combination of database types in a polyglot persistence architecture, allowing the system to leverage the strengths of different database technologies for various aspects of scene storage and retrieval.

A mapping framework 106 may define the spatial and logical relationships between different scenes in the repository. The mapping framework 106 may query the scene repository 104 for spatial metadata and available scene transitions. In some cases, the mapping framework 106 may use a graph-based logic map to connect available scenes with directionality and tags. This structure may allow for non-linear navigation between environments, providing flexibility in how users can move through the virtual space.

The transition module 108 may be responsible for managing the visual aspects of moving between scenes. The transition module 108 may receive mapping data from the mapping framework 106. In some implementations, the transition module 108 may apply visual smoothing, fade, and cut techniques to maintain continuity. These techniques may help create a seamless visual experience as the avatar moves from one pre-rendered scene to another. In some implementations, the transition module 108 implements an anchor-frame routing architecture in which transitions between any two clips route through the per-identity-per-wardrobe master frame rather than requiring direct transitions between each source-destination pair. When a transition is initiated, the transition module 108 plays the current clip’s tail transition segment to the master frame, and then plays the destination clip’s head transition segment from the master frame to the destination clip’s first frame, producing a visually continuous path between any two arbitrary clips in the library.

A continuity engine 110 may focus on maintaining the consistency of the avatar's state, expressions, and animations across scene transitions. In some cases, the continuity engine 110 may include expression interpolation and animation caching for the avatar. This may allow for smooth transitions of the avatar's emotional state and movements between different environments. The continuity engine 110 may utilize technologies such as OpenPose or DeepMotion for avatar animation, enabling realistic and fluid avatar movements. In some implementations, the continuity engine 110 maintains an avatar continuity state comprising at least one of pose state, expression state, gesture state, lip-sync state, voice state, emotion state, memory state, persona state, policy state, retrieval-augmented generation context, session history, application state, spatial coordinates, or compute-placement state, and preserves this continuity state across clip-to-clip transitions, scene-to-scene transitions, application-to-application transitions, and compute-placement-to-compute-placement transitions.

For example, when transitioning from a standing position to a seated position, the system may generate intermediate frames that smoothly interpolate between the two poses. The process may include analyzing key points on the avatar's body, such as joints and limbs, and calculating natural trajectories for each point. The system may also take into account physical constraints and biomechanical principles to ensure the avatar's movements appear natural and weight-bearing. Additionally, the continuity engine 110 may leverage the animation software's capabilities to blend between different emotional expressions, ensuring that the avatar's facial features and body language transition seamlessly between scenes, even if the emotional context changes. This approach may help maintain the illusion of continuous, lifelike behavior for the avatar throughout the user's interaction with the system.

In some implementations, the continuity engine 110 includes a mid-clip morphing module that addresses cases where a clip must be exited prior to its natural end. Real-time conversational avatars must frequently interrupt captured or generated clips because generated dialog audio length is unpredictable and almost never matches the captured talking-clip length, user-driven message timing forces idle-state interruptions at arbitrary moments, and holding silently on a captured clip until it completes naturally produces an unacceptable user experience. For each pre-existing clip in the library, the system pre-generates a set of AI-synthesized exit morph segments at regular interior timestamps, such as every one second beginning at one second into the clip. Each exit morph segment begins on the corresponding interior frame of the source clip and ends on the per-identity-per-wardrobe master frame. At runtime, when the playback engine determines that a clip must be exited at a real-valued time prior to the clip’s natural end, the engine selects the smallest exit timestamp in the morph library that is greater than or equal to the real-valued exit time, plays the clip up to that exit timestamp, and plays the corresponding exit morph segment, whereupon the avatar arrives on the master frame and the next clip may be played beginning from the master frame.

In some implementations, the mid-clip morphing approach produces a morph library whose size grows linearly with the number of pre-existing clips multiplied by the number of exit timestamps per clip, rather than quadratically with the number of source-destination clip pairs. For an outfit with n pre-existing clips and an average of k exit timestamps per clip, the master-frame-routed approach requires n multiplied by k morphs, whereas a direct source-to-destination approach would require n multiplied by k multiplied by n morphs. This represents a substantial reduction in compute, storage, and rendition pipeline cost relative to a direct-transition approach.

In some implementations, because each exit morph terminates on the master frame and each head glue starts on the master frame, a single exit morph asset from a source clip at a given timestamp services transitions to any destination clip in the library. A single morph asset from an idle clip at a given timestamp to the master frame services transitions to any talking clip, any emote clip, any other idle clip, or any frame clip, because the destination side of the transition is handled by the destination clip’s pre-existing head glue segment. This bidirectional reuse is the structural property that bounds the morph library size to source clips multiplied by source timestamps rather than source clips multiplied by source timestamps multiplied by destination clips.

In some implementations, the system exploits a property of an underlying capture protocol wherein the talent returns to a neutral pose between every captured beat, referred to herein as a Pose Zero discipline. Because of this discipline, most interior frames of a captured clip already have a small body-pose delta from the master frame, and the AI morph generation work is predominantly small-delta facial and limb interpolation rather than full-body re-blocking. This property makes the routing-through-neutral approach visually plausible at sub-two-second morph durations and makes the linear morph library size practically feasible at acceptable visual quality.

In some implementations, the continuity engine 110 couples the anchor-frame-routed transition architecture with lip synchronization. Talking assets are loopable in the same manner as non-talking assets. The lip synchronization stage operates on the captured or generated talking-clip portion of the loopable asset only; head and tail glue segments do not contain lip motion because the avatar is in a neutral pose at both ends. This avoids requiring the lip synchronization model to handle synthesized transition frames and keeps the lip synchronization output bounded to captured-frame or generated-frame regions of the source clip.

In some implementations, the system supports a hybrid extension in which a sparse direct-transition library of additional morph segments is overlaid on the master-frame-routed default. Each direct-transition segment is generated for a specific source clip, source timestamp, and destination clip triple. At runtime, the engine consults the direct-transition library first; if no direct transition exists for a given triple, the engine falls back to master-frame routing. This permits per-transition tuning of user-experience quality versus content cost, with direct transitions used only where their quality delta justifies the storage and generation overhead.

The frontend interface 112 may serve as the point of interaction for a user 114 with the scene transition system 100. In some implementations, the frontend interface 112 may support natural language commands, button presses, or keyword recognition for triggering scene transitions. The frontend interface 112 may also incorporate voice recognition and text-to-speech technologies, such as Whisper or Amazon Polly, to enhance the user interaction experience.

In some cases, the scene transition system 100 may integrate large language models (LLMs), such as GPT, for avatar dialogue. This integration may allow for more natural and context-aware conversations between the user and the avatar across different scenes.

The components of the scene transition system 100 may work in concert to create a cohesive and immersive experience. When a user 114 interacts with the frontend interface 112 to request a scene change, the system may access the scene repository 104 to retrieve the appropriate pre-rendered environments. The mapping framework 106 may determine the logical path between the current and target scenes, while the transition module 108 generates the visual transition. Simultaneously, the continuity engine 110 may ensure that the avatar's state and animations remain consistent throughout the transition process.

FIG. 1B depicts a system diagram for the scene transition system 100 in accordance with example embodiments. A server system 152 (i.e., one or more servers) may be in communication, via a network 154, with a user device 156 associated with the user 114.

The scene transition system 100 may utilize various network protocols and communication technologies to facilitate interactions between the user device 156 and the AI avatar across different devices and platforms. In some implementations, the system may employ WebSocket connections for real-time, bidirectional communication between the client-side interface 174 and the server-side components. This may allow for low-latency transmission of user inputs, avatar responses, and scene transition commands. The system may also utilize HTTP/HTTPS protocols for initial data loading, asset retrieval, and non-real-time communications. In cases where the system operates in a distributed environment, it may implement message queuing systems or publish-subscribe patterns to manage asynchronous communications between different components. For mobile and VR applications, the system may leverage platform-specific APIs and SDKs to optimize network performance and handle device-specific requirements. Additionally, the system may employ data compression techniques and efficient serialization formats to minimize bandwidth usage, potentially enabling smooth interactions even on slower network connections.

In some aspects, the interface 174 may be browser-based 168 or incorporated into a dedicated application 170. The interface 174 may be configured to receive a variety of inputs from one or more input devices 176 (e.g., a keyboard 160, mouse 162, microphone 164, touchpad 166, camera, or any other input device).

The user device 156 may interact with an avatar system 172 including frontend interface 112 including a holographic avatar. The frontend interface 112 may further include one or more interface elements (e.g., buttons, text inputs, sliders, etc.) The avatar system 172 may process at least some inputs via an LLM 158.

Inputs relating to a scene transition may call upon the scene transition components 178 including the pre-rendering module 102, the scene repository 104, the scene mapping framework 106, the transition module 108, and the avatar continuity engine 110 as described herein.

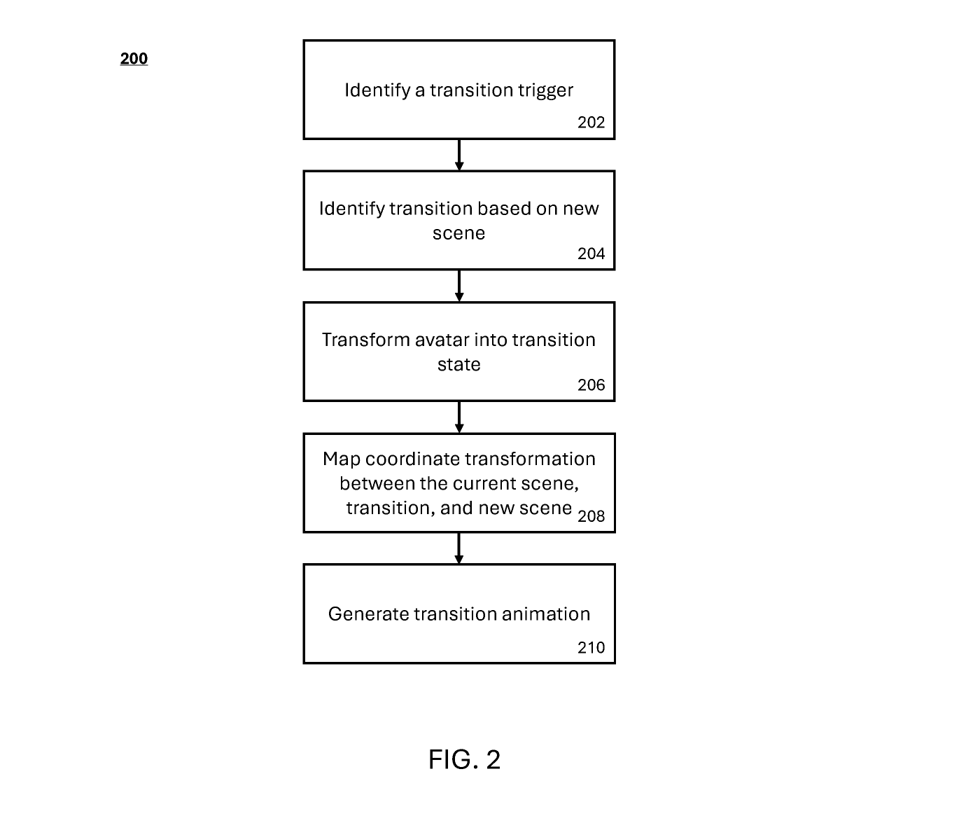

The scene transition system 100 may implement a method 200 for managing scene transitions in the avatar system, as illustrated in FIG. 2. The method 200 may include several steps configured to create a seamless transition experience for the user 114 while maintaining the continuity and realism of the avatar's interactions across different pre-rendered environments.

At step 202, the frontend interface 112 may identify a transition trigger. Alternatively, and/or additionally, the LLM 158 may interpret a user input relating to transition trigger. The frontend interface 112 may receive a transition trigger from a user input relating to an avatar in a current scene. This trigger may take various forms, including, but not limited to a text prompt, a voice command, a gesture, or an interaction with a virtual object within the current environment.

At step 204, the scene mapping framework 106 may identify 204 a target scene from the pre-rendered scenes based on the transition trigger. The scene repository 104 may be queried, for spatial metadata, to determine an appropriate destination environment that aligns with the user's input or the context of the current interaction.

In some embodiments, the frontend interface 112 may be configured to present options for target scenes. The options may be selected based on the current scene.

In some implementations, the method 200 may include identifying a transition scene from the pre-rendered scenes based on the target scene and the current scene. This intermediate scene may serve as a bridge between the current and target environments, facilitating a more natural and gradual transition.

At step 206, the avatar continuity engine 110 may transform the avatar into a transition state. This transformation may involve animating the avatar into a default pose, preparing the character for the upcoming scene change while maintaining visual consistency. The default pose may match an initial pose in the transition scene.

At step 208, the scene mapping framework 106 maps the transition. Coordinate transformations may be mapped between the current scene, the transition scene, and the target scene based on the spatial metadata stored in the scene repository 104. The mapping framework 106 may be utilized to perform these calculations, which may include determining scale differences between the current scene and the target scene. The mapping process may ensure that the avatar's position and orientation remain logical and consistent throughout the transition.

At step 210, the transition module 108 generates 210 a transition animation. The animation may maintain visual continuity of the avatar between the current scene and the target scene based on the mapping. The continuity engine 110 may work in conjunction with the transition module 108 to preserve the avatar's state, expressions, and ongoing animations during this process.

In some cases, the method 200 may further include synchronizing audio effects with the transition animation. This synchronization may enhance the immersive experience by providing auditory cues that match the visual changes in the environment.

The method 200 may include loading transition to the target scene.

The method 200 may include entering the avatar into an idle animation or interactive state in the rendered target scene. This idle state may serve as a starting point for new interactions within the newly loaded environment, allowing the user 114 to seamlessly continue their engagement with the avatar in the new context.

By following this structured approach, the method 200 may enable fluid and believable transitions between pre-rendered scenes, maintaining the illusion of a continuous, navigable environment for the user 114 while optimizing computational resources.

In some implementations, the method 200 may be applied to a combined real-time playback path for clip-level transitions within a single scene. A user sends a chat message; a backend generates a text response and feeds the response through a voice clone text-to-speech model to produce audio; a talking clip is selected from the avatar’s library for the current wardrobe; the talking clip’s captured-frame portion is fed along with the audio through a lip synchronization model, while head and tail glue portions are not processed through lip synchronization; the lip-synced talking clip is sequenced into the playback timeline behind the clip the avatar is currently rendering; because every clip in the library begins and ends on the master frame, the seam between the previous clip and the new talking clip is invisible; and when the response audio ends mid-clip, the playback engine selects the appropriate exit morph to return the avatar to the master frame, from which the next idle or response clip plays seamlessly. The pre-baked anchor-bounded structure makes this real-time path computationally inexpensive because there is no runtime motion synthesis and the AI cost is paid entirely at ingest.

In some implementations, the method 200 incorporates predictive railroad scheduling for interruptions whose destination content is being generated at the moment the interruption begins. The runtime engine treats the transition path as a fixed-duration railroad comprising, in order: the source clip from the current playback position to a chosen exit timestamp, the exit morph from the chosen timestamp to the master frame, the head glue from the master frame to the destination clip’s first frame, and the destination clip. The engine selects the smallest exit timestamp such that the total railroad duration is greater than or equal to the predicted wall-clock time at which the destination content will be ready to play. The predicted destination-ready time may be computed from one or more of a running estimate of text-to-speech synthesis latency, a running estimate of language-model token generation rate, a heuristic estimate of expected response length, and any other available signal regarding the destination content’s expected ready time.

In some implementations, the predictive scheduling enables the avatar to begin a transition path before the destination content is ready, sized so that the destination content becomes ready precisely as the avatar arrives at the destination’s first frame, eliminating both held-silence on the source clip and held-frame waits on the destination clip. In response to updated predictions of destination-ready time received after committing to a transition path, the runtime engine may shift the committed transition path to a later exit timestamp on the source clip if the updated prediction is later than the original, but not to an earlier exit timestamp. If the updated prediction is earlier than the original, the runtime engine may maintain the committed transition path and absorb any slack by holding briefly on the destination clip’s first frame. If the updated prediction is later by more than a threshold amount, the runtime engine may insert a master-frame hold segment of bounded duration before playing the destination clip’s head transition segment.

In some implementations, if an exit morph at the requested exit timestamp is unavailable at runtime due to asset unavailability or network failure, the system selects the nearest available timestamp within plus or minus one interval as a first fallback, accepting a small held-silence or held-frame penalty. As a final fallback, the system performs a hard cut to the destination clip’s head glue segment. This fallback behavior is equivalent to the behavior the system would exhibit without the mid-clip morphing enhancement, ensuring no regression below the pre-invention baseline.

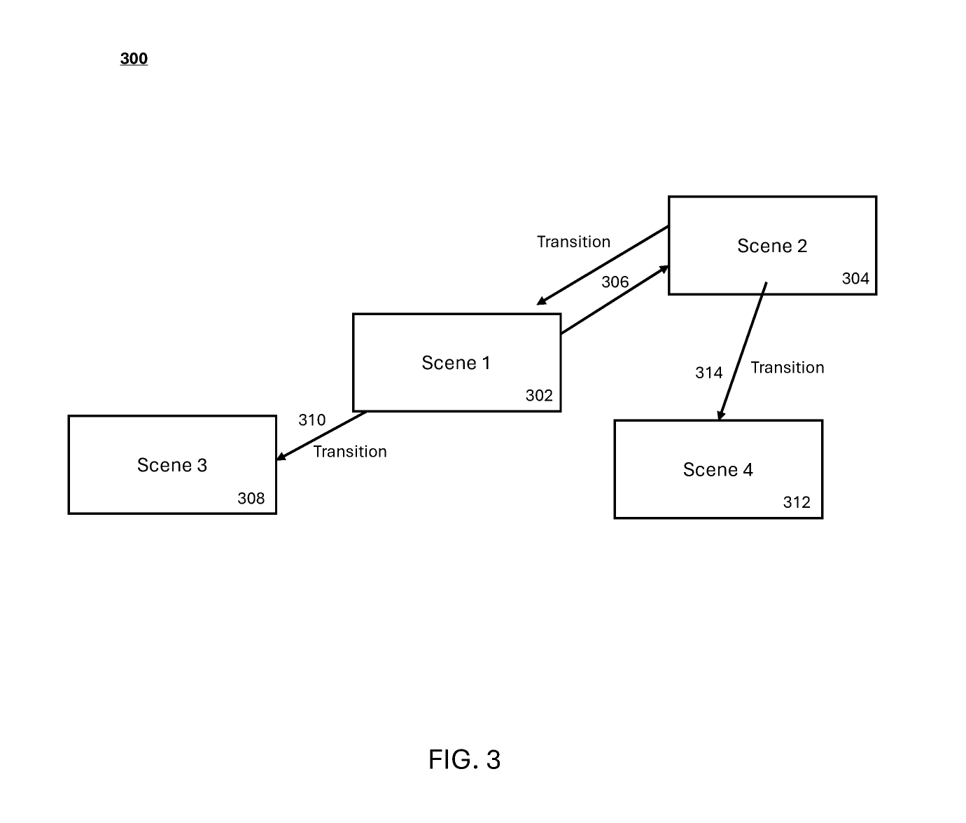

FIG. 3 illustrates a scene navigation map 300, according to example embodiments. In some embodiments, the scene transition system 100 may utilize a scene navigation map 300 to manage the relationships and transitions between multiple pre-rendered scenes. The scene navigation map 300 illustrates a visual representation of how different environments and/or portions of an environment are interconnected, enabling non-linear navigation through the space.

In the illustrated example, the scene navigation map 300 may include a first scene 302. The first scene 302 may be connected to a second scene 304 through a bilateral transition mapping. The bilateral transition mapping may suggest the repository 104 includes transitions 306 from the first scene 302 and the second scene 304 as well as from the second scene 304 to the first scene 302.

In the example, the scene navigation map 300 also includes a third scene 308, which may be connected to the first scene 302 through a transition mapping 310. In some implementations, the transition mapping 310 may represent a one-directional movement capability, allowing users to move from the first scene 302 to the third scene 308, but not necessarily in the reverse direction.

In the example, a fourth scene 312 is present in the scene navigation map 300. The fourth scene 312 is not connected to the first scene 302, suggesting no transition is available. In some embodiments a user may not be able to directly transition between such scenes. Alternatively, a transition between such scenes may include a fade-out/fade-in, swipe transition, or the like. In other embodiments, the system may map complex transitions through multiple scenes to maintain immersion (e.g., first scene 302 to transition 306 to second scene 304 to transition 314 to fourth scene 312).

The mapping framework 106 may utilize the scene navigation map 300 to determine available transition paths between different pre-rendered scenes stored in the scene repository 104. In some cases, the transition module 108 may implement various transition effects based on the relationship between scenes. For example, transitions between closely related scenes may use smooth fade effects, while transitions between disparate environments may employ jump cuts to emphasize the change.

The frontend interface 112 may present transition options to the user 114 based on the current scene and available connections in the scene navigation map 300. In some implementations, not all possible transitions may be presented as options to the user 114. The system may selectively offer transitions based on available transitions, the context of the interaction, the user's history, and/or predefined narrative paths.

In some cases, a transition between scenes may involve a combination of scene transitions. For example, moving from the first scene 302 to the fourth scene 312 may require passing through the second scene 304 or the third scene 308 as intermediate steps. The continuity engine 110 may ensure that the avatar's state and animations remain consistent throughout these multi-step transitions.

The method 200 for managing scene transitions may incorporate the scene navigation map 300 to identify appropriate transition paths. In some implementations, the method 200 may include caching frequently used transition animations to reduce processing time for subsequent transitions. This caching mechanism may improve the responsiveness of the system, particularly for commonly traversed paths between scenes.

The transition trigger for initiating a scene change may comprise at least one of a user gesture, voice command, interaction with a virtual object within the current scene, speech input, application event, scene event, policy event, completion of generated speech, interruption of idle playback, network event, compute-placement event, model-output readiness event, calendar event, conversation event, large-language-model output, gaze event, or user interface selection. For example, the user 114 may use a hand gesture captured by a motion sensor to indicate a desire to move to an adjacent scene. Alternatively, the user 114 may issue a voice command such as "go to the garden" to trigger a transition to a specific environment. In some cases, interacting with a virtual object, such as opening a door or activating a portal within the current scene, may serve as a transition trigger. In some implementations, the system may automatically initiate a transition upon completion of generated speech, upon a model-output readiness event indicating that new content is available for presentation, or upon a policy event requiring the avatar to change contexts.

The scene transition engine may employ various visual techniques to maintain continuity between scenes. In some implementations, the engine may apply visual smoothing, fade effects, and strategic cut techniques to create seamless transitions. The engine may also synchronize avatar exit and entry points between scenes to maintain the illusion of continuous movement.

For the avatar continuity system, advanced tracking mechanisms may be implemented to preserve the avatar's state, expressions, gestures, and audio lip-sync across scene transitions. In some cases, the system may utilize real-time interpolation techniques to prevent abrupt state resets when moving between environments. The continuity system may also incorporate adaptive lighting adjustment to ensure the avatar appears naturally integrated into each new scene.

The scene mapping framework may employ a graph-based logic map to connect available scenes with directionality and tags. This structure may enable non-linear traversal logic, allowing for flexible navigation paths similar to decision trees. In some implementations, the framework may include a spatial relationship database for multiple environments, facilitating dynamic path calculation for natural movement between scenes.

In some cases, the system may incorporate performance optimization techniques to ensure smooth playback of transitions, even on devices with limited computational resources. This may involve careful management of asset loading and unloading, as well as optimized rendering techniques for the avatar and transition effects.

In some implementations, the system dynamically routes generation or rendering operations among a plurality of compute placements based on one or more routing factors. The compute placements may include a user device, browser, mobile processor, local accelerator, neural processing unit, peer device, edge node, private GPU, shared GPU pool, cloud server, or air-gapped appliance. The routing factors may include latency, network condition, battery level, thermal state, privacy policy, security policy, jurisdiction, cost, compute load, GPU availability, model size, accelerator availability, data sensitivity, user preference, or target application requirement. The system preserves the avatar continuity state across compute-placement transitions such that the avatar does not reset when operations migrate between compute locations.

In some implementations, the system prefetches a target visual environment, a voice model, a language model, a retrieval index, or an avatar animation asset based on a predicted transition path in the scene navigation map 300 or a clip-level transition graph. The system may also prefetch likely-needed exit morph segments at the moment a clip begins playing, based on predicted transition probabilities derived from conversation context, user behavior patterns, or language-model output signals.

In some implementations, the system may incorporate advanced memory mechanisms associated with large language models (LLMs) to enhance the avatar's ability to maintain context and personalization across multiple interactions and scene transitions. These memory mechanisms may include short-term and long-term memory components, allowing the avatar to recall recent conversations and user preferences while also retaining important information over extended periods. The system may utilize techniques such as attention mechanisms, memory networks, or external knowledge bases to store and retrieve relevant information. In some cases, the memory mechanisms may employ hierarchical structures to organize and prioritize stored data, enabling more efficient retrieval of contextually appropriate information during conversations. The integration of these memory capabilities with the scene transition system may allow for more coherent and personalized interactions, as the avatar may seamlessly adapt its responses and behaviors based on past experiences and user-specific information, even as the virtual environment changes.

In some implementations, the system preserves at least one guardrail, approved knowledge source, citation state, session memory, role permission, persona constraint, or tool permission across transitions between states, scenes, applications, or compute placements. The guardrail and retrieval-augmented generation continuity ensures that policy enforcement does not lapse during transitions, supporting enterprise deployment use cases where consistent safety and compliance are required throughout avatar interactions.

In some implementations, the AI avatar may function as an intelligent agent capable of directly controlling aspects of the scene transition system. This enhanced functionality may allow the avatar to autonomously initiate and manage scene transitions based on its understanding of the user's intentions, the current context, and/or narrative structures. The avatar may analyze user interactions, speech patterns, and behavioral cues to anticipate desired scene changes, potentially triggering transitions before explicit user commands are given. This proactive approach may create a more fluid and intuitive navigation experience through the virtual environments.

In some implementations, the AI agent architecture may comprise multiple interconnected modules designed to process input, make decisions, and generate outputs within the scene transition system. The architecture may include a perception module for interpreting user inputs and environmental data, a reasoning module that utilizes machine learning algorithms to analyze information and make decisions, and an action module responsible for executing scene transitions and avatar behaviors. A memory module may store and retrieve relevant information, potentially utilizing both short-term and long-term memory structures. The agent may also incorporate a learning module that continuously updates its knowledge base and decision-making processes based on user interactions and system feedback. These components may work in concert, potentially leveraging distributed computing techniques, to enable the AI agent to autonomously navigate the scene transition system, adapt to user preferences, and provide personalized experiences across various virtual environments.

By incorporating these additional features and implementations, the seamless AI avatar scene transition system may provide a robust and flexible platform for creating immersive, interactive experiences across a wide range of applications and use cases.

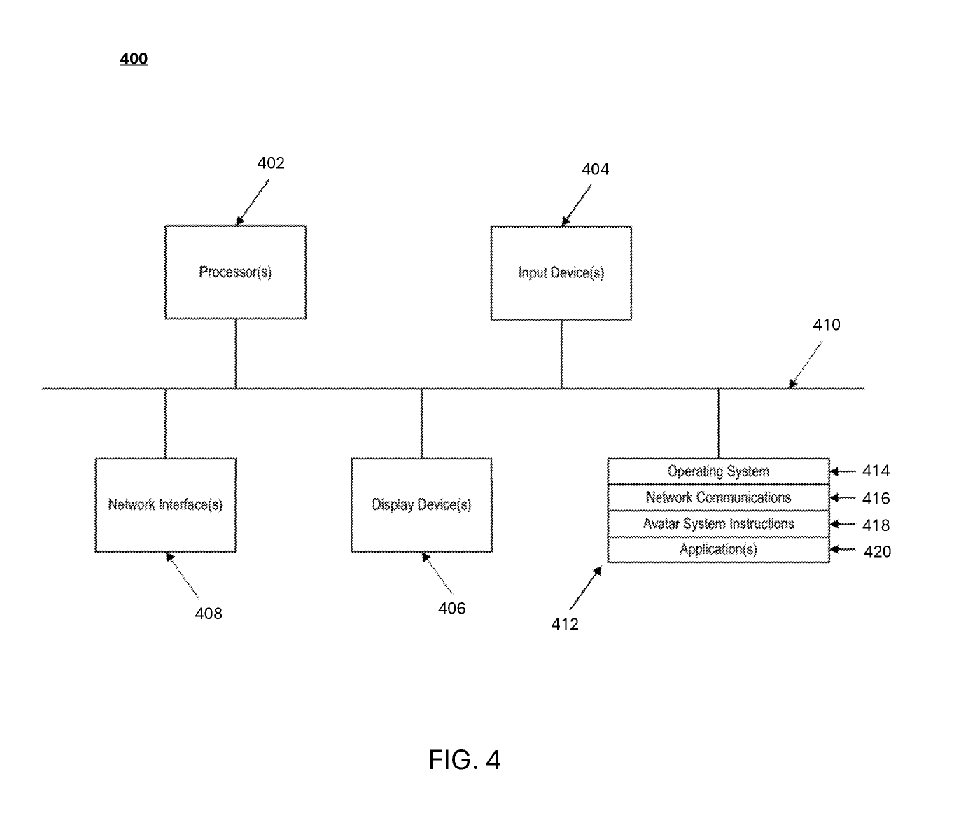

FIG. 4 shows a block diagram of an example computing device 400 that implements various features and processes, according to example embodiments of this disclosure. For example, computing device 400 may function as the server system 152 and/or the user device 156, or a portion or combination thereof in some embodiments. Additionally, the computing device 400 may partially or wholly host and deploy avatar system 172. The computing device 400 may also perform one or more steps of the method 200. The computing device 400 is implemented on any electronic device that runs software applications derived from compiled instructions, including without limitation personal computers, servers, smart phones, media players, electronic tablets, game consoles, email devices, etc. In some implementations, the computing device 400 includes one or more processors 402, one or more input devices 404, one or more display devices 406, one or more network interfaces 408, and one or more computer-readable media 412. Each of these components may be coupled by a bus 410.

Display device 406 includes any display technology, including but not limited to display devices using Liquid Crystal Display (LCD) or Light Emitting Diode (LED) technology. Processor(s) 402 uses any processor technology, including but not limited to graphics processors and multi-core processors. Input device 404 includes any known input device technology, including but not limited to a keyboard (including a virtual keyboard), mouse, track ball, and touch-sensitive pad or display. Bus 410 includes any internal or external bus technology, including but not limited to ISA, EISA, PCI, PCI Express, USB, Serial ATA or FireWire. Computer-readable medium 412 includes any non-transitory computer readable medium that provides instructions to processor(s) 402 for execution, including without limitation, non-volatile storage media (e.g., optical disks, magnetic disks, flash drives, etc.), or volatile media (e.g., SDRAM, ROM, etc.).

Computer-readable medium 412 includes various instructions 414 for implementing an operating system (e.g., Mac OS®, Windows®, Linux). The operating system may be multi-user, multiprocessing, multitasking, multithreading, real-time, and the like. The operating system performs basic tasks, including but not limited to: recognizing input from input device 404; sending output to display device 406; keeping track of files and directories on computer-readable medium 412; controlling peripheral devices (e.g., disk drives, printers, etc.) which can be controlled directly or through an I/O controller; and managing traffic on bus 410. Network communications instructions 416 establish and maintain network connections (e.g., software for implementing communication protocols, such as TCP/IP, HTTP, Ethernet, telephony, etc.).

Avatar system instructions 418 may include instructions that implement one or more of the disclosed modules within avatar system 172, as described throughout this disclosure. Application(s) 420 may comprise an application that uses or implements the processes described herein and/or other processes. The processes may also be implemented in the operating system.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In one embodiment, this may include Python. The computer programs therefore are polyglots.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

Additional examples of the presently described method and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language "means for" or "step for" be interpreted under 35 U.S.C. 112(f). Claims that do not expressly include the phrase "means for" or "step for" are not to be interpreted under 35 U.S.C. 112(f).

1. A computer-implemented method for rendering a real-time video avatar from a library of pre-existing video clips, comprising:
selecting or generating an anchor frame representing a neutral pose of a visual identity for a given identity and wardrobe combination;
for each pre-existing video clip in the library, generating a head transition segment from the anchor frame to a first frame of the pre-existing video clip and a tail transition segment from a last frame of the pre-existing video clip to the anchor frame, and assembling the head transition segment, the pre-existing video clip, and the tail transition segment into a loopable asset whose first and last frames are the anchor frame;
for each pre-existing video clip in the library, generating a plurality of exit morph segments at regular interior timestamps, each exit morph segment beginning on a frame of the pre-existing video clip at a corresponding interior timestamp and ending on the anchor frame;
at runtime, sequencing loopable assets into a playback timeline by concatenating them through a shared anchor frame; and
in response to a determination that a currently playing clip must be exited prior to its natural end, selecting an exit morph segment from the plurality of exit morph segments and playing the selected exit morph segment to arrive on the anchor frame, from which a next loopable asset is played, wherein runtime transitions between any two clips in the library route through the anchor frame without requiring a direct source-to-destination transition for each clip pair.

2. The computer-implemented method of claim 1, wherein the head transition segment and the tail transition segment are each generated by submitting a pair of frames to a frame-to-frame video generation model and receiving as output an AI-synthesized video segment whose first frame matches a starting frame of the pair and whose last frame matches an ending frame of the pair.

3. The computer-implemented method of claim 1, wherein a single exit morph segment from a source clip at a given interior timestamp services transitions to any destination clip in the library without modification.

4. The computer-implemented method of claim 1, further comprising:
during playback of the currently playing clip,
computing a predicted destination-ready time for a destination clip whose content is being generated, and
selecting the exit morph segment such that a total duration of the currently playing clip from a current playback position to the selected exit timestamp, plus a duration of the selected exit morph segment, plus a duration of the destination clip’s head transition segment, is greater than or equal to the predicted destination-ready time.

5. The computer-implemented method of claim 1, further comprising:
applying a lip-synchronization model to a captured-frame or generated-frame portion of a talking loopable asset conditioned on a speech audio waveform.

6. The computer-implemented method of claim 1, further comprising:
maintaining a sparse direct-transition library of morph segments, each generated for a specific source clip, source timestamp, and destination clip triple, and at runtime consulting the direct-transition library before selecting an exit morph segment that routes through the anchor frame.

7. The computer-implemented method of claim 1, wherein the pre-existing video clips comprise one or more of physically captured video of a real human subject, video generated by an artificial-intelligence video generation model from an identity specification, or video produced by artificial-intelligence augmentation of physically captured video.

8. A computer-implemented method for producing a library of seamlessly composable video assets representing a visual identity, comprising:
obtaining a plurality of pre-existing video clips depicting a visual identity;
selecting or generating an anchor frame representing a neutral pose of the visual identity for a given identity and wardrobe combination;
for each pre-existing video clip, generating a head transition segment beginning on the anchor frame and ending on a first frame of the pre-existing video clip, and a tail transition segment beginning on a last frame of the pre-existing video clip and ending on the anchor frame;
assembling, for each pre-existing video clip, the head transition segment, the pre-existing video clip, and the tail transition segment to produce a loopable asset whose first and last frames are the anchor frame; and
storing the loopable assets in an asset library, wherein any two loopable assets from the asset library are concatenable with a seamless visual transition by virtue of sharing the anchor frame as a common first and last frame.

9. The computer-implemented method of claim 8, wherein generating the head transition segment and the tail transition segment comprises:
submitting a frame pair to a frame-to-frame video generation model and receiving as output an AI-synthesized video clip of bounded duration whose first frame matches a starting frame of the frame pair and whose last frame matches an ending frame of the frame pair.

10. The computer-implemented method of claim 8, further comprising:
generating, for each pre-existing video clip, a plurality of exit morph segments at regular interior timestamps within the pre-existing video clip, each exit morph segment beginning on a frame of the clip at a corresponding interior timestamp and ending on the anchor frame, and storing the exit morph segments in a morph library indexed by clip identifier and exit timestamp.

11. The computer-implemented method of claim 8, wherein the anchor frame is selected per identity and wardrobe tuple such that the visual identity has a distinct anchor frame for each wardrobe configuration represented in the library, and wherein transitions between different wardrobe configurations are bridged by dedicated transition assets connecting a first anchor frame for a first wardrobe to a second anchor frame for a second wardrobe.

12. The computer-implemented method of claim 8, further comprising:
generating a plurality of streaming-bandwidth rendition tiers from each loopable asset, wherein the head transition segment and the tail transition segment are generated once at a master quality specification and rendered across the plurality of streaming-bandwidth rendition tiers.

13. The computer-implemented method of claim 8, wherein the plurality of pre-existing video clips are produced under a capture protocol in which a talent returns to a neutral pose between captured sequences, biasing captured first and last frames toward the anchor frame and reducing a magnitude of motion that the head transition segment and tail transition segment are configured to synthesize.

14. The computer-implemented method of claim 8, wherein the plurality of pre-existing video clips comprise one or more of physically captured video of a real human subject, video generated entirely by an artificial-intelligence video generation model from a digital character specification with no physical capture, video produced by AI-augmenting or restyling physically captured video, or a hybrid combination thereof within a single library indexed under a single visual identity.

15. A computer-implemented method for rendering an interruptible video avatar from a clip library, comprising:
maintaining a library of pre-existing video clips depicting a visual identity, each clip having been processed to begin and end on a per-identity-per-wardrobe anchor frame via generated head and tail transition segments;
maintaining a morph library comprising, for each pre-existing video clip, a plurality of exit morph segments at interior timestamps within the pre-existing video clip, each exit morph segment beginning on a frame of the pre-existing video clip at a corresponding interior timestamp and ending on the anchor frame;
during playback of a current clip, determining that the current clip must be exited prior to its natural end;
selecting an exit morph segment from the morph library corresponding to an exit timestamp that is greater than or equal to a current playback position within the current clip; playing the current clip up to the selected exit timestamp, followed by the selected exit morph segment, whereupon the avatar arrives on the anchor frame; and
playing a head transition segment of a destination clip from the anchor frame to a first frame of the destination clip, followed by the destination clip.

16. The computer-implemented method of claim 15, wherein determining that the current clip must be exited prior to its natural end is triggered by at least one of:
completion of generated speech audio before the current clip’s natural end,
arrival of a user input requiring a response while an idle clip is playing, or
a model-output readiness event indicating that a destination clip’s content has become available.

17. The computer-implemented method of claim 15, further comprising:
while the current clip is playing,
computing a predicted destination-ready time for the destination clip based on one or more of a running estimate of text-to-speech synthesis latency, a running estimate of language-model token generation rate, or a heuristic estimate of expected response length, and
selecting the exit morph segment such that the avatar arrives on the first frame of the destination clip at a wall-clock moment substantially coinciding with the destination-ready time.

18. The computer-implemented method of claim 17, further comprising:
in response to an updated prediction of the destination-ready time received after committing to a transition path:
shifting the transition path to a later exit timestamp on the current clip if the updated prediction is later than an original prediction, while constraining against shifting to an earlier exit timestamp; and
if the updated prediction is later than the original prediction by more than a threshold amount, inserting an anchor-frame hold segment of bounded duration before playing the destination clip’s head transition segment.

19. The computer-implemented method of claim 15, wherein, if the selected exit morph segment is unavailable at runtime, a fallback is performed comprising selecting a nearest available exit morph segment within plus or minus one timestamp interval, or performing a hard cut to the destination clip’s head transition segment.

20. The computer-implemented method of claim 15, further comprising:
prefetching one or more exit morph segments predicted to be needed based on a predicted transition path.
